(19) United States
(12) Patent Application Publication
(10) Pub. No.: US 2010/0301288 A1
(43) Pub. Date: Dec. 2, 2010

(54) PREPARATION OF NUCLEAR FUEL COMPOSITION AND RECYCLING

(75) Inventors: JONATHAN PHILLIPS, Rio Rancho, NM (US); STEVAN G. PATTILLO, Jemez Springs, NM (US); JAMES A. VALDEZ, Dixon, NM (US); GORDON D. JARVINEN, Los Alamos, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(73) Assignee: Los Alamos National Security, LLC, Los Alamos, NM (US)

(21) Appl. No.: 12/476,015

(22) Filed: Jun. 1, 2009

(51) Int. Cl. C09K 11/04

(52) U.S. Cl. 252/638

(57) ABSTRACT

A composition is prepared by heating particles of a nuclear fuel material in a metal salt that decomposes below 1000° C. to form a metal oxide. Magnesium nitrate hexahydrate is an example of such a metal salt. A resulting composition includes the particles homogeneously dispersed in a matrix of magnesium oxide. After the composition is used in a nuclear reactor, the now spent composition is removed, cooled, and the matrix is dissolved away from the spent particles, which can be reused in another nuclear fuel composition. The recovered fuel particles also contain some fission products that provide a radiation barrier that discourages theft of the recovered fuel particles.

### STATEMENT REGARDING FEDERAL RIGHTS

This invention was made with government support under Contract No. DE-AC52-06NA25396 awarded by the U.S. Department of Energy. The government has certain rights in the invention.

### FIELD OF THE INVENTION

The present invention relates to a nuclear fuel composition from which fission products are readily separated from radioactive actinides after the nuclear fuel composition is used for energy production.

### BACKGROUND OF THE INVENTION

The disposal of spent nuclear fuel remains a major technical problem for the nuclear industry worldwide. This problem must be solved before nuclear energy becomes a more broadly accepted energy technology. The U.S. Global Nuclear Energy Partnership (“GNEP”) was founded to support an expansion of civilian nuclear power production worldwide. A goal of this program is to develop and deploy advanced recycle technology for recovering the energy value of the actinides from the spent nuclear fuel and preparing the fission products from the spent nuclear fuel for disposal.

Currently, there is no fuel that permits ready separation of fission products and radioactive actinides in spent nuclear fuel (“SNF”).

### SUMMARY OF THE INVENTION

In accordance with the purposes of the present invention, as embodied and broadly described herein, an aspect of the invention is concerned with a method for preparing a composition having a nuclear fuel material. The method involves heating a mixture of magnesium nitrate hexahydrate and micron sized particles of a nuclear fuel material to a temperature suitable for the magnesium nitrate hexahydrate to decompose to form magnesium oxide, water, and nitrogen oxides, and afterward cooling the resulting mixture, and recovering a product that has particles of a nuclear fuel material that are homogeneously dispersed in a matrix of magnesium oxide.

The invention is also concerned with a method of recycling the irradiated composition. The method involves heating a mixture of magnesium nitrate hexahydrate and particles of a nuclear fuel material to a temperature suitable for the magnesium nitrate hexahydrate to decompose to form magnesium oxide, water, and nitrogen oxides, and afterward cooling the resulting mixture, and recovering a product that is a composition of particles of a nuclear fuel material that are homogeneously dispersed in a matrix of magnesium oxide. The composition is then used in a nuclear reactor. After a period of time the now spent composition, after having undergone nuclear fission in the reactor, is removed. The spent nuclear fuel particles produced nuclear energy and fission products. Much of the fission products are retained in the matrix of magnesium oxide. After removing the composition from the reactor and allowing radioactive decay of fission products and actinides to proceed for a period of time that could be months or even years, the matrix is dissolved and then separated from the used particles of nuclear fuel material. This separates at least some of the fission products from the used particles of nuclear fuel material, which are reused to make another nuclear fuel composition.

The invention is also concerned with a method for preparing a nuclear fuel composition of particles of a nuclear fuel material homogeneously dispersed in a metal oxide matrix. The particles can have a size on the micron scale, but can also be larger or smaller. The method involves heating a mixture of particles of a radioactive nuclide and a metal salt that thermally decomposes at a temperature below 1000° C. The mixture is heated to a temperature suitable for the metal salt to decompose and form metal oxide, water, and gaseous products. Afterwards, the resulting mixture is cooled. After cooling, a product is recovered that is a composition of particles of a nuclear fuel material that are homogeneously dispersed in a matrix of metal oxide.

The invention is also concerned with a method of recycling nuclear fuel particles from an irradiated nuclear fuel composition of particles of a nuclear fuel material homogeneously dispersed in a metal oxide matrix. The method first involves forming a composition by heating a mixture of particles of nuclear fuel material and a metal salt that thermally decomposes at a temperature below 1000° C. The mixture is heated to a temperature suitable for the metal salt to decompose and form metal oxide, water, and gaseous products. Afterward the mixture is cooled. After cooling, a product is recovered that is a composition of particles of a nuclear fuel material that are homogeneously dispersed in a matrix of metal oxide. The particles can be of a size on the micron scale (from 1 to 1000 microns). The particles can also be larger than micron scale, and also smaller than micron scale. After forming the composition, the method includes using the composition in a nuclear reactor. After a period of time, the composition is converted into a composition with spent (i.e. used) particles of nuclear fuel. The composition is then removed from the nuclear reactor and radioactive decay of the fission products and actinides allowed to proceed for a period of time that can be months or even years. The spent composition comprises a matrix of metal oxide and used nuclear fuel particles dispersed in the matrix. The used nuclear fuel particles have undergone fission in the nuclear reactor and produced nuclear energy and fission products. The spent nuclear fuel particles are substantially insoluble in the matrix of metal oxide, and much of the fission products are retained in the matrix. The size of the particles is generally a micron scale size, which is a small size so that the fission products escape the particle and come to rest in the matrix. After allowing the spent composition to cool, the oxide matrix from the composition is dissolved and the spent nuclear fuel particles are separated from the dissolved matrix. After they are separated, the nuclear fuel particles can be reused in another composition.

The invention also includes a method for preparing a composite of particles in a matrix of a metal oxide. The method involves heating a mixture of particles of a phase and a metal salt that thermally decomposes at a temperature below 1000° C. to a temperature suitable for the metal salt to decompose and form metal oxide, water, and gaseous products; cooling the resulting mixture; and recovering a product that is a composition of particles of the phase of the original particles that are homogeneously dispersed in a matrix of metal oxide.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 shows an experimental set-up for preparing an embodiment composition

FIG. 2 shows a Thermogravimetric analysis (“TGA”) plot and a differentially scanning calorimetry (“DSC”) plot of thermal decomposition of magnesium nitrate hexahydrate.

FIG. 3 shows W/Mn particles randomly distributed in a MgO matrix.

FIG. 4 shows a three-dimensional micro x-ray computed tomographic image of W/Mn particles well dispersed in MgO. The field of view is approximately 1-cm.

### DETAILED DESCRIPTION

An aspect of the present invention is a method for preparing a composition for producing energy in a nuclear reactor. The composition is designed such that after it used, and transformed into a spent composition, a simple, straightforward separation of fission products from radioactive actinides after the composition is used for energy production allows the spent fuel to be recycled and reused in another nuclear fuel composition. An embodiment composition includes micron-sized particles of nuclear fuel dispersed in an inert matrix. The inert matrix is a metal oxide matrix. In an embodiment, the majority of the composition is the inert matrix. In an embodiment, the majority of the composition is magnesium oxide.

When the composition is used for energy production, nuclear fuel particles in the composition produce fission products that escape from the nuclear fuel particles and come to rest in the inert matrix. The inert matrix material is an inert material that retains the fission products but not react with the nuclear fuel particles. By dissolving the inert matrix, it can be separated along with the retained fission products away from the insoluble nuclear fuel particles simply by filtration or centrifugation. The separated nuclear fuel particles can then be recycled while the solution containing the matrix and fission products can be processed for disposal.

The invention has been demonstrated using MgO as an inert matrix, and sub-millimeter sized particles of W(shell)/Mo(core) or HfO₂, surrogates for a nuclear fuel material such as UO₂ or PuO₂. These compositions were prepared by first mixing the surrogate particles with magnesium nitrate hexahydrate. The mixture was heated in air or under an inert atmosphere until the magnesium nitrate hexahydrate decomposed to form magnesium oxide (“MgO”).

The invention employs a composition that is prepared by replacing the surrogate particles with particles having a radioactive actinide, e.g. PuO₂, UO₂, for example. Uranium and plutonium are examples of fissionable actinides that form oxides. The oxides produce nuclear energy and fission products. In an embodiment using uranium oxide and a matrix of magnesium oxide, for example, the UO₂ particles produce fission products that come to rest in the matrix of magnesium oxide. After producing nuclear energy in a nuclear reactor, the composition of UO₂ in the MgO matrix is removed from the reactor and allowed to cool. The composition is then mixed with a solvent such as water, an acid solution, or a weakly basic solution, which dissolves the matrix of magnesium oxide matrix and fission products (“FPs”) in the matrix, but does not dissolve the UO₂ particles.

MgO is completely soluble in acid solutions and even in a weakly basic aqueous solution near room temperature (see: Pourbaix, “Atlas of Electrochemical Equilibria in Aqueous Solutions”, National Assoc. of Corrosion Eng., Houston Tex. (1974)). In contrast, actinides are soluble only in strong acids. For example, uranium dioxide and plutonium dioxide are virtually insoluble, for pH>1. Moreover, studies of the kinetics of MgO dissolution show that the rates are reasonably high even for weak acid solutions (see: Fedorockova et al. “Effects of pH and acid anions on the dissolution kinetics of MgO,” J. Chem. Eng., vol. 143, pp. 265-272 (2008); Jones et al., “The Effect of Irradiation on the Dissolution Rate of Magnesium Oxide,” Radiation Effects, vol. 60, pp. 167-171, (1982); and Majias et al., “The Kinetics and Mechanism of MgO Dissolution,” Chem. Phys. Lett, vol, 314, pp. 558-563, (1999)). The undissolved UO₂ particles in the example are then separated from the dissolved matrix by simple filtration or centrifugation from the aqueous solution that contains the dissolved matrix and soluble fission products.

The invention provides a method for separating actinides and fission products. The bulk of the fission products are readily separated from the actinide fuel particles by selective dissolution of the matrix. The particles of actinide fuel (e.g. UO₂, PuO₂) are readily recycled for further energy production. New fuel material can be added to supplement the actinides that have already undergone a fission reaction. Actinide particles that have been recycled from an embodiment composition still retain a small fraction of fission products and therefore must be handled remotely. However, the fission products in these recovered actinides provide a substantial radiation barrier that discourages theft of this material while it is refabricated into new fuel and returned to a nuclear reactor for further energy production. The small fraction of fission products that deposit in the fuel particles is not enough to be a significant neutron poison in the refabricated fuel, but is enough to make diversion and theft of this material dangerous and very difficult.

The following examples illustrate preparation of a composition using surrogate particles in a matrix of MgO.

### EXAMPLE 1

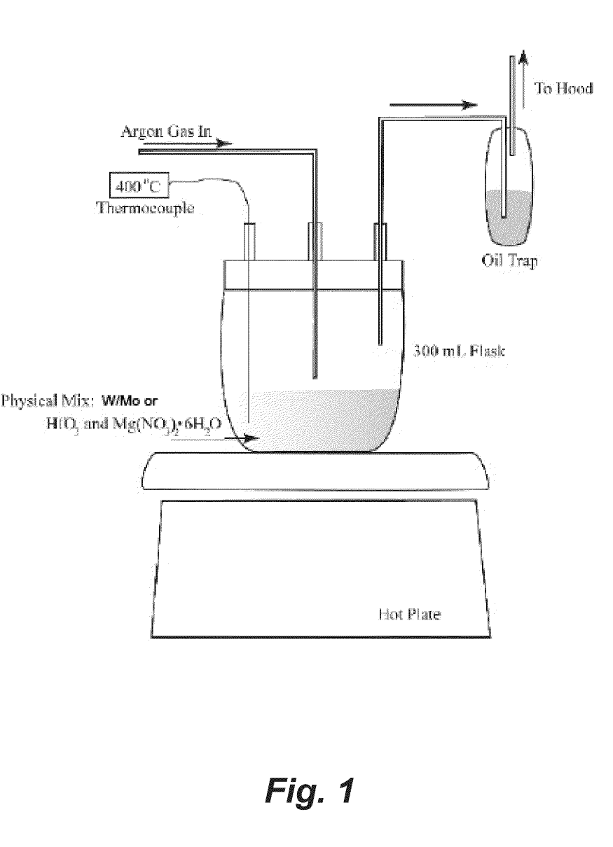

A mixture of approximately 60 weight percent HfO₂ in magnesium nitrate hexahydrate was prepared. Approximately 200 milligrams of the mixture was placed inside a vessel. FIG. 1 shows an experimental set-up of the apparatus used. A thermocouple was placed in the mixture. The mixture was heated to 425° C. under a low flow rate of argon or air. Afterward, the flask was removed and cooled. The atmosphere in the vessel can be controlled, and the temperature read with the thermocouple in the powder. Various maximum temperatures were tried. Initial experiments were conducted at 150° C. Thermogravimetric analysis (“TGA”) indicated that full decomposition occurred upon heating to 425° C. for 1 hour. Thus, the mixture was heated for at least 1 hour at 425° C. The heating protocol for the samples was as follows: The sample was heated under air from room temperature to about 300° C. at a rate of 10° C. per minute. Frothing became apparent. Once the temperature reached 300° C., the frothing ceased and the sample appeared solid. The heating rate was change to a rate of approximately 4° C. per minute. At a temperature of about 350° C., a brown/yellow gas, presumably NO₂, was observed in the flask above the sample. Once the temperature reached 425° C., the reaction was deemed complete and the sample was removed from the hot plate and allowed to cool. Argon and air were both tried as the gas and the results are indistinguishable from one another.

After cooling in flowing gas, the sample was removed intact using a small scraper. The sample was hard and brittle. It was cut in half using a handheld jigsaw with a diamond tipped blade. The sample did not crumble, and a clean cut resulted.

The sample was analyzed by X-ray diffraction. Data were collected using a BRUKER D8 Advance diffractometer using Cu Ka radiation and operating at 40 kV and 40 ma. Data was collected from 10° to 70° 2θ using a step size of 0.02 and a count time of 5 sec/step in detector scan mode with the X-ray source fixed at 8°.

Scanning electron micrograph (“SEM”) images were taken using an instrument made by HITACHI.

Differential scanning calorimetry (“DSC”) and thermogravimetric analysis (“TGA”) were performed simultaneously using a NETZCHE Model STA 449C instrument.

Digital X-ray radiographs were collected using an XRANDIA MSCT (Concord, Calif.). The source voltage was a HAMMATSU microfocus tungsten source. Images were collected using 1 minute exposures with various objectives with 1-cm to 1.2 mm fields of view. Images were also collected in mosaic mode for high resolution images of larger areas. The samples were either mounted using a vacuum tip, or by setting on a stage.

Chemical analyses were performed at GALBRAITH LABORATORIES (Knoxville, Tenn.).

Some visual observations during the heating that suggest chemical processes were occurring. First, at about 100° C., the sample became plastic in appearance and frothed. Frothing began at around 90° C. Bubbles having a size of about 1 cm across began to form and pop. This frothing action, which occurred without any external mechanical agitation (e.g. no stirring) kept the sample well mixed, and likely accounts for the homogeneous dispersion of the HfO₂ particles in the final cooled material. It also suggests an origin of the bubble voids in the sample. Next, at approximately 400° C. a brown/orange gas evolved from the mixture very quickly.

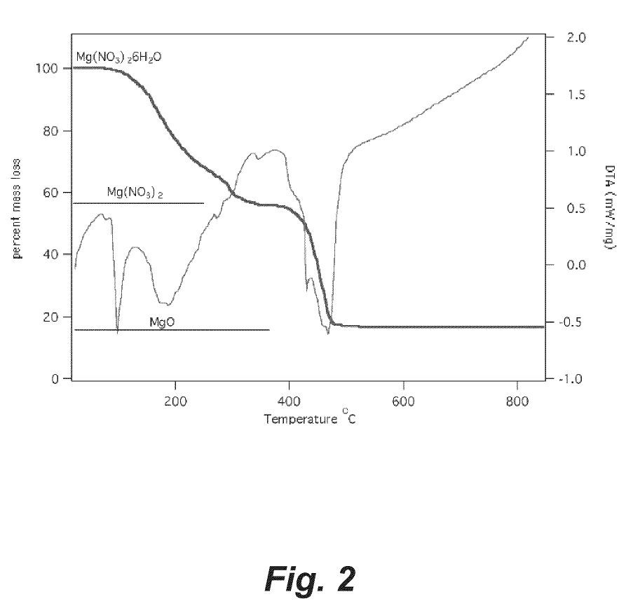

Analysis by TGA/DSC of a sample of about 50 mg suggested that the frothing occurred due to gas evolution from the sample. As shown in FIG. 2, sample steadily lost weight from about 100° C. to about 300° C. At this point, the weight loss slowed. A plateau in weight was observed from about 300° C. to almost 400° C. From about 400° C. to 500° C., a sharp rapid weight loss was observed. The sample weight stabilized afterward. FIG. 2 also shows some fractional mass loss values. While not wishing to be bound by any particular explanation, the weight loss observations can be explained by the following interpretation. Weight lost from 100° C. to 300° C. likely results from loss of water. The fractional weight lost at the plateau (approximately 55% from 300° C. to 400° C.) corresponds to a complete dehydration. The much sharper weight loss that began at 400° C. leads to a final weight that is consistent with the formation of MgO. This suggests that NO groups are released from the material once the temperature reaches approximately 400° C. This interpretation is supported by the visual observation of an orange/brown gas (e.g. NO₂) evolving at elevated temperature.

Digital X-ray radiographic images indicate that the higher “Z” material, i.e. HfO₂, is uniformly dispersed. A digital radiograph of a sample decomposed at only 100° C. shows that the sample does not have a homogeneous dispersion of HfO₂. The sample was mounted upside down in the radiography instrument. The HfO₂ particles in this sample were collected at the bottom of the sample, which suggests that without sufficient frothing action, denser particles settle by gravity to the bottom. Digital X-ray radiographic images of two samples decomposed at 400° C. showed HfO₂ to be uniformly dispersed. Interestingly, a visual inspection does not indicate that the HfO₂ became segregated; to the eye, there is little to distinguish the samples obtained at higher temperature (T>400° C.) from those obtained at lower temperature (T approximately 100° C.).

A chemical analysis (GALBRAITH Labs) revealed a Mg/Hf ratio that was constant for all six samples generated at T>400° C. Two samples of the six samples were taken from the top of the recovered product, two from the middle, and two from the bottom. The Mg/Hf ratio in all cases was virtually identical.

### EXAMPLE 2

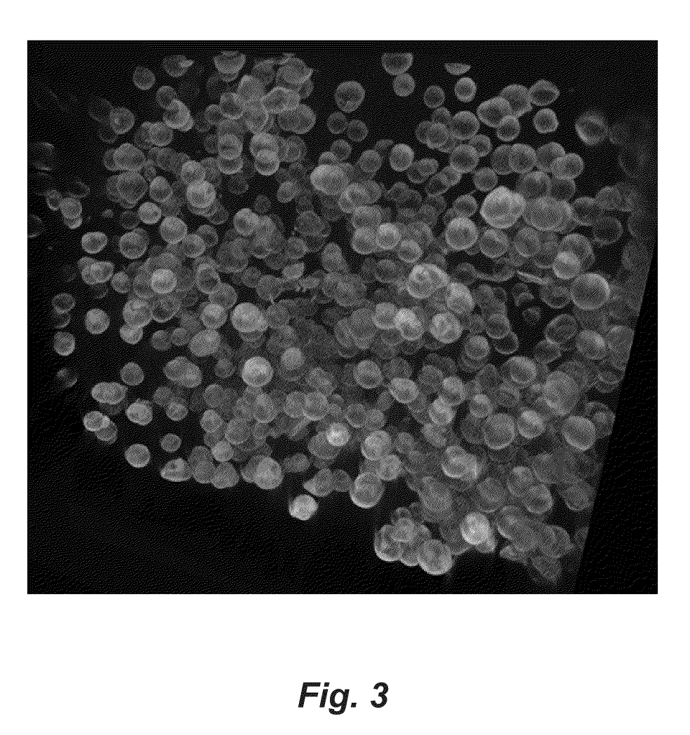

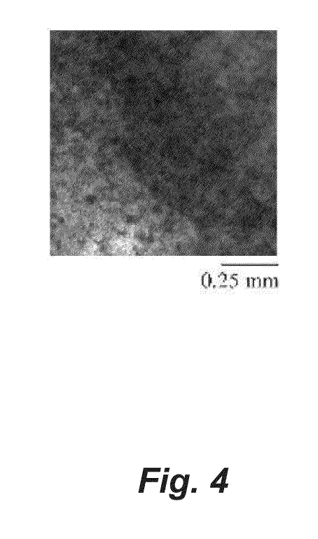

This EXAMPLE is substantially equivalent to EXAMPLE 1. The metal particles in EXAMPLE 2 were not HfO₂, but rather sub-millimeter sized particles of W(shell)/Mo(core) that have a specific gravity of about 12. In this EXAMPLE, the starting mixture was about 75% metal particles by weight. The results in terms of XRD and TGA/DSC were substantially equivalent to those observed for EXAMPLE 1. A random distribution of the metal particles within the MgO matrix was also observed (see FIG. 3 and FIG. 4).

The EXAMPLES above illustrate several non-limiting embodiments of this invention. In a more general method, a metal salt other than magnesium oxide hexahydrate is the precursor for a metal oxide matrix. Thus, it should be understood that other oxides besides magnesium oxide can be formed as long as a metal salt is used that can be thermally decomposed when heated at a temperature below 1000° C. Thus, the method of preparation of a composition of this invention is more generally a method for preparing a composition of particles (generally micron scale sized particles) of a radioactive nuclide homogeneously dispersed in a metal oxide matrix. Thus, a mixture of micron sized particles of a radioactive nuclide and a metal salt that thermally decomposes at a temperature below 1000° C. is prepared and then heated to a temperature suitable for the metal salt to decompose and form metal oxide. Water and gaseous by products may also be formed during the decomposition. Afterward, the resulting mixture is cooled, and a product is recovered that is a nuclear fuel composition of micron scale particles of a radionuclide that are homogeneously dispersed in a matrix of metal oxide. This composition may be used in a nuclear reactor, and energy may be produced using this composition. Afterward, the composition is converted into a spent fuel composition, and the spent fuel composition may be recycled by removing the spent fuel composition from the nuclear reactor and allowed to cool, and then the matrix of metal oxide may be dissolved and the spent fuel particles separated from the matrix. Then, the spent fuel particles, which are micron scale particles of the radionuclide may be reused to prepare another nuclear fuel composition.

The more general method of preparation may employ a metal salt that can include one or metals such as, but not limited to, aluminum, magnesium, yttrium, cerium, niobium, zirconium, and tantalum. A preparation may also include mixtures of these metals. Mixtures of metal salts, each with a decomposition temperature below 1000° C. that form metal oxides, may be used.

The more general method may be employed wherein the metal salt is a hydrate.

The more general method may be employed wherein the metal salt is a chloride salt, a butoxide salt, an ethoxide salt, or an acetate salt, wherein the metal salt can also include one or more of aluminum, magnesium, yttrium, zirconium, cerium, niobium, or tantalum.

Embodiments of the more general method may employ one or more metal salts selected from magnesium nitrate hexahydrate, magnesium acetate tetrahydrate, magnesium acetylacetone dehydrate, magnesium bis(monoperoxyphthalate) hexahydrate, magnesium bis(2,2,6,6-tetramethyl-3,5-heptand-ionate hydrate), magnesium carbonate hydroxide pentahydrate, magnesium carbonate hydroxide hydrate, magnesium chloride, magnesium dichloride hexahydrate, magnesium di-tert-butoxide, or magnesium ethoxide.

Even more generally, the invention is concerned with a method for preparing a composite of particles in a matrix of a metal oxide. The method involves heating a mixture of particles of a phase and a metal salt that thermally decomposes at a temperature below 1000° C. to a temperature suitable for the metal salt to decompose and form metal oxide, water, and gaseous products; cooling the resulting mixture; and recovering a product that is a composition of particles of the phase of the original particles that are homogeneously dispersed in a matrix of metal oxide. The particles are of a material selected from metal, metal oxide, carbide, nitride, phosphide, and sulfide.

In summary, a method for preparing a composition has been developed. Actinides from the composition, after a period of energy production, can be readily separated from fission products. The preparation has been demonstrated using a mixture of surrogate particles of HfO₂ or W(shell)/Mo(core) and magnesium nitrate hexahydrate. The mixtures were heated in a beaker without mechanical mixing to 425° C. The products were consistent with a solid ceramic of a MgO matrix and micron scale particles uniformly dispersed in an MgO matrix. Dispersion was likely a result of internal agitation from generating water and NO₂ during nitrate decomposition. Separation of MgO from the particles of metal oxide, metal or metal alloy can be readily achieved because the MgO is soluble but the particles are not. It is expected that replacement of the surrogate particles by a particles containing a radioactive actinide (e.g. UO₂, PuO₂, a mixture of UO₂ and PuO₂) provides a composition for producing nuclear energy and fission products, and the radioactive actinide can later be separated from the MgO matrix by dissolving the MgO and soluble fission products followed by simple filtration. The invention meets a major goal of the Global Nuclear Energy Partnership (“GNEP”) program by providing recycle technology for nuclear energy production. The benefits are a greatly reduced cost of the actinide/fission product separation process and a relatively easy recycle process of spent fuel particles. The spent fuel particles contain fission products and therefore provide a radiation barrier that discourages theft or diversion of the recycled fuel particles as they are recycled into new fuel.

The foregoing description of the invention has been presented for purposes of illustration and description and is not intended to be exhaustive or to limit the invention to the precise form disclosed, and obviously many modifications and variations are possible in light of the above teaching.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method for preparing a composition of particles of a nuclear fuel material homogeneously dispersed in a matrix of magnesium oxide, comprising:
heating a mixture of magnesium nitrate hexahydrate and particles of a nuclear fuel material to a temperature suitable for the magnesium nitrate hexahydrate to decompose to form magnesium oxide, water, and nitrogen oxides, and
cooling the resulting mixture, and
recovering a product that is a composition of particles of a nuclear fuel material that are homogeneously dispersed in a matrix of magnesium oxide.

2. The method of claim 1, wherein the nuclear fuel material comprises uranium, plutonium, and mixtures thereof.

3. The composition of claim 1, wherein nuclear fuel material comprises uranium oxide, plutonium oxide, and mixtures thereof.

4. The composition of claim 1, wherein the particles are micron scale sized particles.

5. A method of recycling nuclear fuel particles, comprising:
heating a mixture of magnesium nitrate hexahydrate and micron sized particles of a nuclear fuel material to a temperature suitable for the magnesium nitrate hexahydrate to decompose to form magnesium oxide, water, and nitrogen oxides, and
cooling the resulting mixture, and thereafter
recovering a product that is a composition of micron scale particles of a nuclear fuel material that are homogeneously dispersed in a matrix of magnesium oxide,
using the composition in a nuclear reactor, and after a period of time,
removing spent composition from the nuclear reactor, the spent composition comprising a matrix of magnesium oxide and spent nuclear fuel particles dispersed in the matrix, the spent nuclear fuel particles having undergone fission and produced nuclear energy and fission products, wherein at least some of the fission products are retained by the matrix, and thereafter
dissolving the matrix of magnesium oxide, and thereafter
separating the spent nuclear fuel particles from the dissolved matrix of magnesium oxide.

6. The method of claim 5, wherein the nuclear fuel material comprises a radioactive actinide.

7. The method of claim 5, wherein the nuclear fuel material is selected from plutonium oxide, uranium oxide, and mixtures thereof.

8. The method of claim 5, further comprising reusing spent nuclear fuel particles that have been separated from the dissolved matrix of magnesium oxide.

9. The method of claim 5, wherein the nuclear fuel material comprises uranium, plutonium, or mixtures thereof.

10. The composition of claim 1, wherein the nuclear fuel material comprise uranium oxide, plutonium oxide, of mixtures thereof.

11. A method for preparing a composition of particles of a nuclear fuel material homogeneously dispersed in a metal oxide matrix, comprising:
heating a mixture of particles of a nuclear fuel material and a metal salt that thermally decomposes at a temperature below 1000° C. to a temperature suitable for the metal salt to decompose and form metal oxide, water, and gaseous products;
cooling the resulting mixture; and
recovering a product that is a composition of particles of nuclear fuel material that are homogeneously dispersed in a matrix of metal oxide.

12. The method of claim 11, wherein the particles of nuclear fuel material are micron scale sized particles.

13. The method of claim 11, wherein the metal salt includes a metal selected from aluminum, magnesium, yttrium, cerium, niobium, zirconium, tantalum, and mixtures thereof.

14. The method of claim 11, wherein the metal salt is a hydrate.

15. The method of claim 11, wherein the metal salt is a chloride salt, a butoxide salt, an ethoxide salt, or an acetate salt, the metal salt comprising one or more of aluminum, magnesium, yttrium, zirconium, cerium, niobium, or tantalum.

16. The method of claim 11, wherein the metal salt is selected from magnesium nitrate hexahydrate, magnesium acetate tetrahydrate, magnesium acetylacetone dehydrate, magnesium bis(monoperoxyphthalate) hexahydrate, magnesium bis(2,2,6,6-tetramethyl-3,5-heptand-ionate hydrate), magnesium carbonate hydroxide pentahydrate, magnesium carbonate hydroxide hydrate, magnesium chloride, magnesium dichloride hexahydrate, magnesium di-tert-butoxide, or magnesium ethoxide.

17. A method of recycling nuclear fuel particles, comprising:
forming a composition by heating a mixture of particles of a nuclear fuel material and a metal salt that thermally decomposes at a temperature below 1000° C. to a temperature suitable for the metal salt to decompose and form metal oxide, water, and gaseous products, and thereafter cooling the resulting mixture, and thereafter recovering a product that is a composition of particles of a nuclear fuel material that are homogeneously dispersed in a matrix of metal oxide, and thereafter
using the composition in a nuclear reactor whereby spent composition is produced,
removing spent composition from the nuclear reactor, the spent composition comprising a matrix of magnesium oxide and spent nuclear fuel particles dispersed in the matrix, the spent nuclear fuel particles having undergone fission and produced nuclear energy and fission products, wherein at least some of the fission products are retained by the matrix, and thereafter
dissolving the matrix of metal oxide, and thereafter
separating the spent nuclear fuel particles from the dissolved matrix of metal oxide.

18. The method of claim 17, wherein the particles of a nuclear fuel material are micron scale sized particles.

19. The method of claim 17, wherein the metal salt includes a metal selected from aluminum, magnesium, yttrium, cerium, niobium, zirconium, tantalum, and mixtures thereof.

20. The method of claim 17, wherein the metal salt is a hydrate.

21. The method of claim 17, wherein the metal salt is a chloride salt, a butoxide salt, an ethoxide salt, or an acetate salt, the metal salt comprising one or more of aluminum, magnesium, yttrium, zirconium, cerium, niobium, or tantalum.

22. The method of claim 17, wherein the metal salt is selected from magnesium nitrate hexahydrate, magnesium acetate tetrahydrate, magnesium acetylacetone dehydrate, magnesium bis(monoperoxyphthalate) hexahydrate, magnesium bis(2,2,6,6-tetramethyl-3,5-heptand-ionate hydrate), magnesium carbonate hydroxide pentahydrate, magnesium carbonate hydroxide hydrate, magnesium chloride, magnesium dichloride hexahydrate, magnesium di-tert-butoxide, or magnesium ethoxide.

23. The method of claim 17, wherein the metal oxide is magnesium oxide.
